(19) United States
(12) Patent Application Publication
(10) Pub. No.: US 2017/0149458 A1
(43) Pub. Date: May 25, 2017

(54) DISTORTION COMPENSATION DEVICE AND DISTORTION COMPENSATION METHOD

(71) Applicant: FUJITSU LIMITED, Kawasaki-shi (JP)

(72) Inventors: Tomoya Ota, Kawasaki (JP); HIROYOSHI ISHIKAWA, Kawasaki (JP); Kazuo Nagatani, Yokohama (JP)

(73) Assignee: FUJITSU LIMITED, Kawasaki-shi (JP)

(21) Appl. No.: 15/286,777

(22) Filed: Oct. 6, 2016

(30) Foreign Application Priority Data
Nov. 20, 2015 (JP) 2015-228051

(51) Int. Cl. H04B 1/04

(52) U.S. Cl. CPC H04B 1/0475; H04B 2001/0425

(57) ABSTRACT

A distortion compensation device includes an address generating unit, an LUT, and a multiplier. The address generating unit calculates the magnitude of a first vector and the angle formed by the first vector and a second vector. The first vector is represented by using the origin in an IQ coordinate plane as the starting point and using a transmission signal point at a first time as the end point. The second vector is represented by using a transmission signal point at a second time that is predetermined time before the first time as the starting point and using the transmission signal point at the first time as the end point. The LUT specifies a distortion compensation coefficient by using the calculated magnitude and the calculated angle. The multiplier performs a predistortion process on a transmission signal input to an amplifier by using the specified distortion compensation coefficient.

### CROSS-REFERENCE TO RELATED APPLICATION

This application is based upon and claims the benefit of priority of the prior Japanese Patent Application No. 2015-228051, filed on Nov. 20, 2015, the entire contents of which are incorporated herein by reference.

### FIELD

The embodiments discussed herein are directed to a distortion compensation device and a distortion compensation method.

### BACKGROUND

A radio transmitter is provided with an amplifier that amplifies power of transmission signals. In the radio transmitter, in general, in order to increase the power efficiency of the amplifier, the amplifier is operated in the vicinity of the saturation region of the amplifier. However, when the amplifier is operated in the vicinity of the saturation region, nonlinear distortion of the amplifier is increased. Thus, to meet the standard, such as an adjacent channel leakage ratio (ACLR), the spectrum emission mask (SEM), or the like, by reducing the nonlinear distortion, the radio transmitter is provided with a distortion compensation device that compensates nonlinear distortion.

A “predistortion (hereinafter, sometimes referred to as “PD”) method” is used as one of distortion compensation methods that is used in the distortion compensation device. In the distortion compensation device that uses the PD method, a distortion compensation coefficient that has the inverse properties of the nonlinear distortion of the amplifier is previously multiplied by the transmission signal that is input to the amplifier. Consequently, the linearity of an output from the amplifier is increased and distortion of an output from the amplifier is reduced.

Furthermore, in the amplifier with high power efficiency, it is known that a phenomenon called memory effect occurs. The memory effect is a phenomenon in which an output with respect to an input to an amplifier at a certain time is affected by an input in the past. In a distortion compensation method that compensates nonlinear distortion of an amplifier, there is a method that also compensates the memory effect in addition to the nonlinear distortion. With this method, in a transmission signal that has the I component and the Q component, a distortion compensation coefficient is determined by using information on a phase difference between the vector starting from the origin in the IQ coordinate plane to the current transmission signal point and the vector starting from the origin in the IQ coordinate plane to the transmission signal point at a predetermined time before. Related-art examples are described in Japanese Laid-open Patent Publication No. 2011-199428; Japanese Laid-open Patent Publication No. 2011-199429; U.S. Patent Application Publication No. 2011/0227643; and U.S. Patent Application Publication No. 2011/0227644.

However, in an amplifier, if the amplitude of an input signal is small, the nonlinear distortion included in the signal amplified by the amplifier is not so great, whereas if the amplitude of an input signal is great, the nonlinear distortion included in the signal amplified by the amplifier is large. Namely, the nonlinear distortion, when the amplitude of the signal that is input to the amplifier is great, is dominant. Thus, the improvement of the distortion compensation performance is more expected when the nonlinear distortion with large amplitude is compensated rather than the nonlinear distortion with small amplitude. Furthermore, in order to effectively use a limited circuit, the resolution of the distortion compensation coefficient is preferably increased when the amplitude of the input signal is large rather than when the amplitude of the input signal is small.

In a conventional distortion compensation method, a distortion compensation coefficient is determined on the basis of a phase difference between the current sample point of a transmission signal and a sample point of the transmission signal at a predetermined time before. Thus, the resolution in an area away from the origin in the IQ coordinate plane is lower than the resolution in the vicinity of the origin in the IQ coordinate plane. FIG. 10 is a schematic diagram illustrating the resolution of a distortion compensation coefficient in a conventional distortion compensation method. In FIG. 10, the white circle represents the current sample point x(t) of the transmission signal and the black circles represent the sample points x(t−Δt) delayed by the predetermined time Δt from the current sample of the transmission signal. For example, as illustrated in FIG. 10, the case in which the current sample point x(t) of the transmission signal is changed from one of the samples x(t−Δt) at a predetermined time before is considered. FIG. 10 illustrates a case in which the resolution Δθ₀ of the phase difference is 60 degrees.

In the example illustrated in FIG. 10, the phase difference Δθ between the vector of the current sample point x(t) of the transmission signal and the vector of each of the sample points x(t−Δt) of the transmission signal at the predetermined time before is included in an area 70 of the angular range of Δθ₀ (for example, 60 degrees) in the IQ coordinate plane. Thus, in the conventional distortion compensation method, even if the current sample point x(t) of the transmission signal is changed from one of the sample points x(t−Δt) illustrated in FIG. 10, regarding the phase difference Δθ between x(t) and x(t−Δt), the same distortion compensation coefficient is determined. Thus, in the conventional distortion compensation method, it is difficult to distinguish each of the changes between the sample points in the transmission signal illustrated in FIG. 10 and determine a distortion compensation coefficient in accordance with the change in each of the transmission signals.

Furthermore, in also the conventional distortion compensation method, by increasing the resolution of an angle, it is also possible to distinguish each of the changes between the sample points in the transmission signal illustrated in FIG. 10 and associate each of the changes with different distortion compensation coefficients. However, if the resolution of an angle is increased in the conventional distortion compensation method, the number of coefficients is increased in the distortion compensation that uses power series and the number of tables is accordingly increased in the distortion compensation that uses a Look Up Table (LUT); therefore, the size of a circuit becomes large and it takes time for convergence of the distortion compensation coefficients.

### SUMMARY

According to an aspect of an embodiment, a distortion compensation device includes a calculating unit, a specifying unit, and a distortion compensation unit. The calculating unit calculates a magnitude of a first vector and an angle formed by the first vector and a second vector. The first vector is a vector represented by using an origin in an IQ coordinate plane as a starting point and using a transmission signal point at a first time as an end point. The second vector is a vector represented by using a transmission signal point at a second time that is predetermined time before the first time as a starting point and using the transmission signal point at the first time as an end point. The specifying unit specifies a distortion compensation coefficient by using the magnitude of the first vector and the angle formed by the first vector and the second vector calculated by the calculating unit. The distortion compensation unit performs, by using the distortion compensation coefficient specified by the specifying unit, a predistortion process on a transmission signal that is input to an amplifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a distortion compensation device;

FIG. 2 is a block diagram illustrating an example of an address generating unit according to a first embodiment;

FIG. 3 is a schematic diagram illustrating the direction of a second vector;

FIG. 4 is a schematic diagram illustrating an example of an input angle;

FIG. 5 is a schematic diagram illustrating an example of the resolution of a distortion compensation coefficient according to the first embodiment;

FIG. 6 is a flowchart illustrating an operation of the distortion compensation device according to the first embodiment;

FIG. 7 is a block diagram illustrating an example of an address generating unit according to a second embodiment;

FIG. 8 is a schematic diagram illustrating an example of the resolution of a distortion compensation coefficient according to the second embodiment;

FIG. 9 is a block diagram illustrating an example of hardware of the distortion compensation device; and

FIG. 10 is a schematic diagram illustrating the resolution of a distortion compensation coefficient in a conventional distortion compensation method.

### DESCRIPTION OF EMBODIMENTS

Preferred embodiments of the present invention will be explained with reference to accompanying drawings. The distortion compensation device and the distortion compensation method disclosed in the present application are not limited to the embodiments described below. Furthermore, the embodiments can be used in any appropriate combination as long as the processes do not conflict with each other.

### [a] First Embodiment

Distortion Compensation Device 10

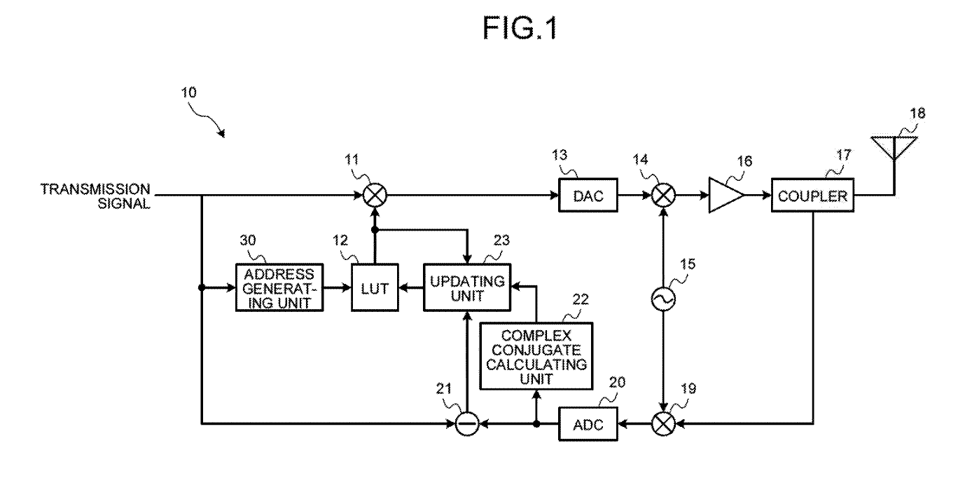

FIG. 1 is a block diagram illustrating an example of the distortion compensation device 10. The distortion compensation device 10 includes a multiplier 11, an LUT 12, a digital-to-analog converter (DAC) 13, an up converter 14, an oscillator 15, an amplifier 16, a coupler 17, and an antenna 18. Furthermore, the distortion compensation device 10 according to the embodiment includes a down converter 19, an analog-to-digital converter (ADC) 20, a subtracter 21, a complex conjugate calculating unit 22, an updating unit 23, and an address generating unit 30. In a radio communication system that has, for example, a base station and a terminal, the distortion compensation device 10 is mounted on the base station or the terminal or, alternatively, mounted on both the base station and the terminal.

In the embodiment, the transmission signal is, for example, a digital baseband signal that includes therein an in-phase component signal (I signal) and a quadrature component signal (Q signal). The address generating unit 30 calculates the amplitude of a first vector that indicates the current sample point of the transmission signal. The first vector is, for example, the vector, in the IQ coordinate plane, represented by using the origin in the IQ coordinate plane as the starting point and using the sample point of the transmission signal at the first time as the end point. In the embodiment, the first time is, for example, the current time. Furthermore, the address generating unit 30 calculates the input angle formed by the first vector and a second vector. The second vector is, for example, the vector, in the IQ coordinate plane, represented by using the sample point of the transmission signal at the second time that is a predetermined time before the first time as the starting point and using the sample point of the transmission signal at the first time as the end point.

Then, the address generating unit 30 outputs the value of the amplitude of the first vector to the LUT 12 as a first address. Furthermore, the address generating unit 30 outputs the value of the input angle to the LUT 12 as a second address. The address generating unit 30 is an example of a calculating unit.

The LUT 12 specifies a distortion compensation coefficient by using the input angle calculated by the address generating unit 30. Specifically, the LUT 12 holds, for example, a distortion compensation coefficient by associating the distortion compensation coefficient with the combination of the first address and the second address. When the first address and the second address are output from the address generating unit 30, the LUT 12 specifies the distortion compensation coefficient that is associated with the combination of these addresses. Then, the LUT 12 outputs the specified distortion compensation coefficient to the multiplier 11. The LUT 12 is an example of a specifying unit.

By using the distortion compensation coefficient specified by the LUT 12, the multiplier 11 performs a predistortion process on the transmission signal that is input to the amplifier 16. Specifically, the multiplier 11 performs the predistortion process on the transmission signal by multiplying the distortion compensation coefficient output from the LUT 12 by the transmission signal. Then, the multiplier 11 outputs the transmission signal that has been subjected to the predistortion process (hereinafter, referred to as a PD signal) to the DAC 13. The multiplier 11 is an example of a distortion compensation unit.

The DAC 13 converts the PD signal that has been output from the multiplier 11 from a digital signal to an analog signal. Then, the DAC 13 outputs the PD signal converted to the analog signal to the up converter 14.

The up converter 14 up-converts, by using the local oscillator signal output from the oscillator 15, the PD signal that has been converted to the analog signal. A quadrature modulator, a mixer, or the like is included in the up converter 14. Then, the up converter 14 outputs the up-converted PD signal to the amplifier 16.

The amplifier 16 amplifies the power of the PD signal that has been up-converted by the up converter 14. Then, the amplifier 16 outputs, to the coupler 17, the signal in which the power has been amplified.

The coupler 17 outputs, to the antenna 18, the signal in which the power has been amplified by the amplifier 16 and feeds back a part of the signal to the down converter 19. The signal that has been output to the antenna 18 is emitted to space from the antenna 18.

The down converter 19 down-converts, by using the local oscillator signal output from the oscillator 15, the signal that has been fed back from the coupler 17. A quadrature demodulator, a mixer, or the like is included in the down converter 19. Then, the down converter 19 outputs the down-converted signal to the ADC 20.

The ADC 20 converts the signal that has been down-converted by the down converter 19 from the analog signal to the digital signal. Then, the ADC 20 outputs the signal converted to the digital signal to both the subtracter 21 and the complex conjugate calculating unit 22.

The subtracter 21 calculates a difference between the transmission signal and the signal output from the ADC 20. The subtracter 21 outputs the calculated differential signal to the updating unit 23.

The complex conjugate calculating unit 22 calculates the complex conjugate of the signal output from the ADC 20. Then, the complex conjugate calculating unit 22 outputs the calculated complex conjugate signal to the updating unit 23.

The updating unit 23 calculates an updated distortion compensation coefficient on the basis of the distortion compensation coefficient output from the LUT 12, the differential signal output from the subtracter 21, and the complex conjugate signal output from the complex conjugate calculating unit 22. The updating unit 23 calculates the updated distortion compensation coefficient by using, for example, the algorithm, such as least mean square (LMS), recursive least squares (RLS), or the like. Then, the updating unit 23 updates the distortion compensation coefficient in the LUT 12 by using the calculated distortion compensation coefficient.

Details of the Address Generating Unit 30

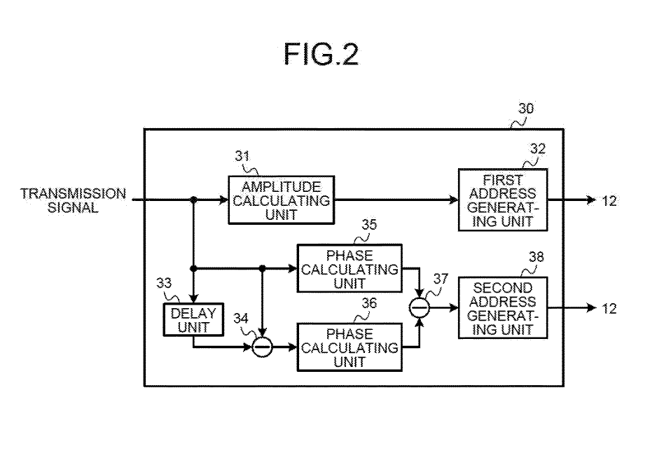

In the following, details of the address generating unit 30 will be described. FIG. 2 is a block diagram illustrating an example of the address generating unit 30 according to a first embodiment. The address generating unit 30 according to the embodiment includes an amplitude calculating unit 31, a first address generating unit 32, a delay unit 33, a subtracting unit 34, a phase calculating unit 35, a phase calculating unit 36, a subtracting unit 37, and a second address generating unit 38.

The amplitude calculating unit 31 calculates the amplitude of the first vector. The first vector is the vector, in the IQ coordinate plane, represented by using the origin of the IQ coordinate plane as the starting point and using the current sample point x(t) of the transmission signal as the end point. The amplitude calculating unit 31 calculates, as the amplitude of the first vector, for example, the square root of the sum of the square of the I component of the first vector and the square of the Q component of the first vector. The amplitude of the first vector is an example of the index indicating the magnitude of the first vector.

The first address generating unit 32 normalizes the value of the amplitude of the first vector calculated by the amplitude calculating unit 31 to the first address with a predetermined number of bits. Then, the first address generating unit 32 outputs the first address to the LUT 12.

The delay unit 33 delays the current sample point x(t) of the transmission signal by the predetermined time Δt. The subtracting unit 34 calculates the second vector by subtracting the sample point x(t−Δt) of the transmission signal delayed by Δt by the delay unit 33 from the current sample point x(t) of the transmission signal. In the embodiment, the second vector is represented by x(t)−x(t−Δt).

The phase calculating unit 35 calculates the phase θ₁(t) of the first vector represented by using the origin in the IQ coordinate plane as the starting point and using the current sample point x(t) of the transmission signal as the end point. The phase θ₁(t) calculated by the phase calculating unit 35 is represented by, for example, Equation (1) below.

$${θ}_{1} ( t ) = {tan}^{- 1} \frac{Im [ x ( t ) ]}{Re [ x ( t ) ]} \qquad ( 1 )$$

The phase calculating unit 36 calculates the phase θ₂(t) of the second vector calculated by the subtracting unit 34. The phase θ₂(t) to be calculated by the phase calculating unit 36 is represented by, for example, Equation (2) below.

$${θ}_{2} ( t ) = {tan}^{- 1} \frac{Im [ x ( t ) - x ( t - Δ t ) ]}{Re [ x ( t ) - x ( t - Δ t ) ]} \qquad ( 2 )$$

The subtracting unit 37 calculates the input angle Δθᵢₙ(t) on the basis of both the phase θ₁(t) of the first vector calculated by the phase calculating unit 35 and the phase θ₂(t) of the second vector calculated by the phase calculating unit 36. Specifically, the subtracting unit 37 calculates the input angle Δθᵢₙ(t) by using, for example, Equation (3) below.

$${Δθ}_{in} ( t ) = {θ}_{2} ( t ) - {θ}_{1} ( t ) = {tan}^{- 1} \frac{Im [ x ( t ) - x ( t - Δ t ) ]}{Re [ x ( t ) - x ( t - Δ t ) ]} - {tan}^{- 1} \frac{Im [ x ( t ) ]}{Re [ x ( t ) ]} \qquad ( 3 )$$

The second address generating unit 38 normalizes the value of the input angle Δθᵢₙ(t) calculated by the subtracting unit 37 to the second address with a predetermined number of bits. Then, the second address generating unit 38 outputs the second address to the LUT 12.

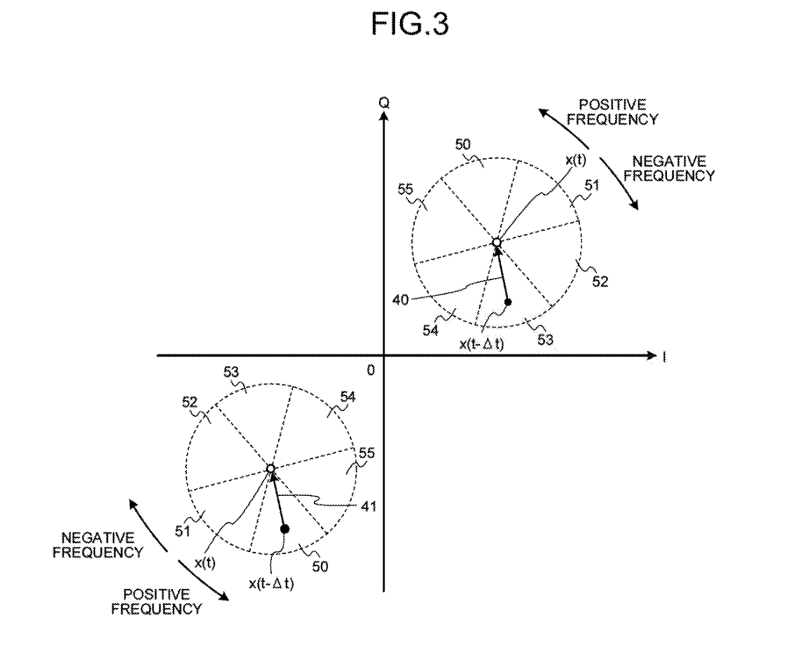

In the following, the direction of the second vector will be described. FIG. 3 is a schematic diagram illustrating the direction of the second vector. In the IQ coordinate plane illustrated in FIG. 3, when a positive frequency is included in a change in the sample point of the transmission signal, the sample point of the transmission signal is rotated counterclockwise around the origin in the IQ coordinate plane. In contrast, when a negative frequency is included in a change in the sample point of the transmission signal, the sample point of the transmission signal is rotated clockwise around the origin in the IQ coordinate plane. Furthermore, in FIG. 3, the white circle represents the current sample point x(t) of the transmission signal and the black circle represents the sample point x(t−Δt) delayed by Δt from the current sample point of the transmission signal.

Reference numerals 40 and 41 illustrated in FIG. 3 indicate the second vector represented by using the sample point x(t−Δt) as the starting point and using the sample point x(t) as the end point. The phase θ₂(t) of the second vector 40 is calculated by Equation (2) above. However, the rotational component (frequency) is not represented only by the phase θ₂(t) of the second vector 40. For example, as illustrated in FIG. 3, it is assumed of a case in which the second vector 40 is located in the first quadrant in the IQ coordinate plane, the second vector 41 is located in the third quadrant in the IQ coordinate plane, and the phase θ₂(t) of the second vector 40 and the phase θ₂(t) of the second vector 41 are the same.

In this case, the second vector 40 located in the first quadrant indicates the positive frequency component and the second vector 41 located in the third quadrant indicates the negative frequency component. However, if a distortion compensation coefficient is specified by only using the phase θ₂(t), the same distortion compensation coefficient is specified for both the second vectors 40 and 41.

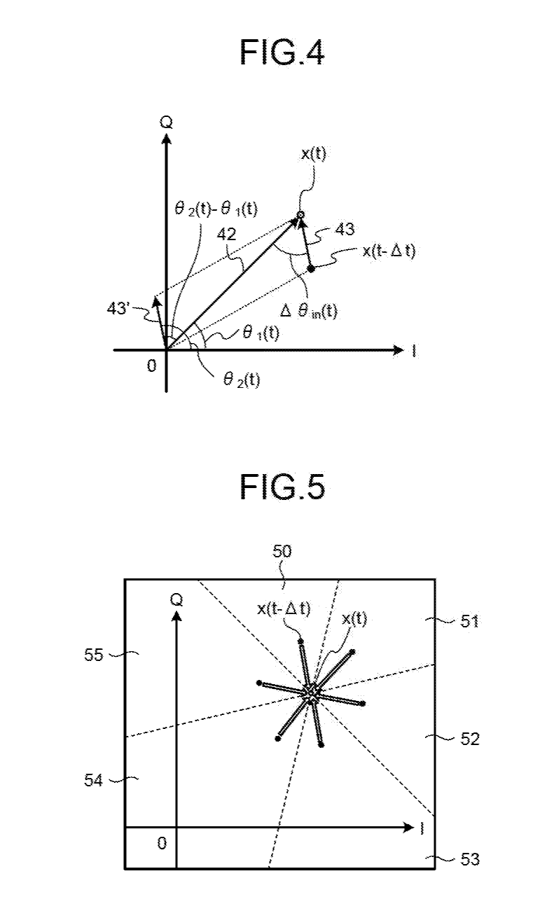

Thus, the distortion compensation device 10 according to the embodiment calculates, by using a first vector as the reference, the input angle Δθᵢₙ(t) that is the phase difference between the first vector and a second vector and then specifies the distortion compensation coefficient by using the calculated input angle Δθᵢₙ(t). FIG. 4 is a schematic diagram illustrating an example of an input angle. When the second vector 43 is translated in the IQ coordinate plane such that the starting point falls on the origin in the IQ coordinate plane, the angle formed by the translated second vector 43′ and the first vector 42 is the angle, as illustrated in FIG. 4, obtained by subtracting the phase θ₁(t) of the first vector 42 from the phase θ₂(t) of the second vector 43′. Furthermore, the relationship between the angle formed by the second vector 43′ and the first vector 42 and the input angle Δθᵢₙ(t) is, as illustrated in FIG. 4, alternate-interior angles. Thus, the input angle Δθᵢₙ (t) is θ₂(t)−θ₁(t).

By specifying the distortion compensation coefficient using the input angle Δθᵢₙ(t), for example, as illustrated in FIG. 3, the angular range of 360 degrees is divided into, for example, equal six parts and, if a distortion compensation coefficient is associated with each of the angular ranges, regarding the second vector 40 located in the first quadrant, the distortion compensation coefficient associated with an area 53 is used. In contrast, regarding the second vector 41 located in the third quadrant, the distortion compensation coefficient associated with an area 50 that is different from the area 53 is used. Thus, the distortion compensation device 10 can distinguish the second vectors including the rotational components and can allocate different distortion compensation coefficients to the respective second vectors. Furthermore, in the example illustrated in FIG. 3, each of the areas 50 to 55 of the angular ranges indicated in the first quadrant and each of the areas 50 to 55 of the angular ranges indicated in the third quadrant has the relationship in which the areas in one of the quadrants are rotated around the origin in the IQ coordinate plane by 180 degrees.

At this point, in the conventional distortion compensation, for example, as described with reference to FIG. 10, the angular ranges associated with the distortion compensation coefficients are set by using the origin in the IQ coordinate plane as the center. Thus, in the IQ coordinate plane, in an area away from the origin, i.e., in an area in the vicinity of the current sample point x(t) of the transmission signal when the amplitude is large, the resolution of the angle is low. Therefore, for example, in the example illustrated in FIG. 10, even when the current sample point x(t) of the transmission signal is shifted from one of the sample points x(t−Δt), the same distortion compensation coefficient is used. Thus, it is difficult to improve the distortion compensation performance.

In contrast, with the distortion compensation device 10 according to the embodiment, the input angle Δθᵢₙ(t) is calculated by using the first vector as the reference and the distortion compensation coefficient is specified by using the calculated input angle Δθᵢₙ(t). Thus, with the distortion compensation device 10 according to the embodiment, for example, as illustrated in FIG. 5, in the IQ coordinate plane, in an area away from the origin, i.e., in an area in the vicinity of the current sample point x(t) of the transmission signal when the amplitude is large, a predetermined resolution can be obtained. FIG. 5 is a schematic diagram illustrating an example of the resolution of a distortion compensation coefficient according to the first embodiment. FIG. 5 exemplifies the resolution obtained by dividing 360 degrees into equal six parts with its center at the current sample point x(t) of the transmission signal.

For example, when compared with a case in which 360 degrees are divided into equal six parts, in the distortion compensation method according to the embodiment illustrated in FIG. 5, the resolution of the angle is higher in an area in which the amplitude of the transmission signal is large than that in the conventional distortion compensation method illustrated in FIG. 10. Thus, the distortion compensation device 10 according to the embodiment can more precisely identify the frequency properties in the area in which the amplitude of the transmission signal is large and use different distortion compensation coefficients in accordance with the respective frequency properties. Therefore, the distortion compensation device 10 according to the embodiment can reduce nonlinear distortion affected by the memory effect of the amplifier 16 more than before.

Furthermore, even if the same resolution as that used in the conventional device is used, the distortion compensation device 10 according to the embodiment can increase the resolution in the area in which the amplitude of the transmission signal is large. Thus, even if the number of addresses set in the LUT 12 is about the same number of addresses used in the past, the distortion compensation device 10 according to the embodiment can efficiently reduce nonlinear distortion of the amplifier 16 due to the memory effect or the like. Therefore, the distortion compensation device 10 according to the embodiment can improve the distortion compensation performance while reducing an increase in the size of a circuit.

Operation of the Distortion Compensation Device 10

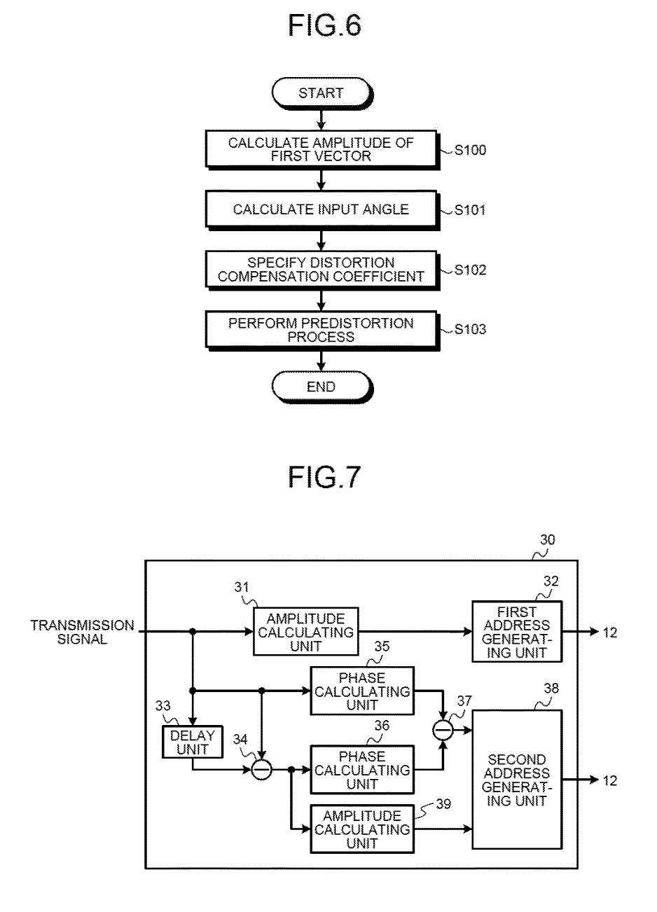

In the following, the operation of the distortion compensation device 10 according to the first embodiment will be described. FIG. 6 is a flowchart illustrating an operation of a distortion compensation device 10 according to the first embodiment. The distortion compensation device 10 performs the operation indicated by the flowchart for each, for example, sample timing of the transmission signal.

First, when the transmission signal is input, the amplitude calculating unit 31 calculates the amplitude of the first vector, in the IQ coordinate plane, represented by using the origin of the IQ coordinate plane as the starting point and using the current sample point x(t) of the transmission signal as the end point (Step S100). Then, the first address generating unit 32 normalizes the value of the amplitude of the first vector calculated by the amplitude calculating unit 31 to the first address with a predetermined number of bits and then outputs the normalized value to the LUT 12.

Then, the address generating unit 30 calculates the input angle that is the angle formed by the first vector and the second vector (Step S101). Specifically, the delay unit 33 delays the current sample point x(t) of the transmission signal by the predetermined time Δt. The subtracting unit 34 calculates the second vector by subtracting the sample point x(t−Δt) from the sample point x(t). The phase calculating unit 35 calculates the phase θ₁(t) of the first vector. The phase calculating unit 36 calculates the phase θ₂(t) of the second vector. The subtracting unit 37 calculates the input angle Δθᵢₙ(t) by subtracting the phase θ₁(t) of the first vector from the phase θ₂(t) of the second vector. Then, the second address generating unit 38 normalizes the value of the input angle Δθᵢₙ(t) to the second address with the predetermined number of bits and then outputs the second address to the LUT 12.

Then, the LUT 12 specifies the distortion compensation coefficient associated with the first address and the second address output from the address generating unit 30 (Step S102). Then, the LUT 12 outputs the specified distortion compensation coefficient to the multiplier 11. The multiplier 11 performs the predistortion process on the transmission signal that is input to the amplifier 16 by multiplying the distortion compensation coefficient specified by the LUT 12 by the transmission signal (Step S103).

### Effect of the First Embodiment

As is clear from the description above, in the distortion compensation device 10 according to the embodiment, the address generating unit 30 calculates the magnitude of the first vector and calculates the angle formed by the first vector and the second vector. The first vector is the vector represented by using the origin in the IQ coordinate plane as the starting point and using the transmission signal point at the first time as the end point. The second vector is the vector represented by using the transmission signal point at the second time that is a predetermined time before the first time as the starting point and using the transmission signal point at the first time as the end point. Furthermore, in the distortion compensation device 10 according to the embodiment, the LUT 12 specifies distortion compensation coefficient by using the magnitude of the first vector and the angle formed by the first vector and the second vector calculated by the address generating unit 30. Furthermore, in the distortion compensation device 10 according to the embodiment, by using the distortion compensation coefficient specified by the LUT 12, the multiplier 11 performs the predistortion process on the transmission signal input to the amplifier 16. Consequently, the distortion compensation device 10 according to the embodiment can improve the distortion compensation performance while reducing an increase in the size of a circuit.

### [b] Second Embodiment

The distortion compensation device 10 according to a second embodiment differs from the distortion compensation device 10 according to the first embodiment in that distortion compensation coefficient is specified by further using the magnitude of the second vector. Furthermore, the overall configuration of the distortion compensation device 10 is the same as that in the first embodiment except for the address generating unit 30. Thus, in a description below, the configuration of the address generating unit 30 is mainly described.

FIG. 7 is a block diagram illustrating an example of the address generating unit 30 according to a second embodiment. The address generating unit 30 according to the second embodiment includes the amplitude calculating unit 31, the first address generating unit 32, the delay unit 33, the subtracting unit 34, the phase calculating unit 35, the phase calculating unit 36, the subtracting unit 37, the second address generating unit 38, and an amplitude calculating unit 39. Furthermore, the blocks illustrated in FIG. 7 having the same reference numerals as those illustrated in FIG. 2 have the same configuration as the blocks illustrated in FIG. 2 except for the following points described below; therefore, descriptions thereof will be omitted.

The amplitude calculating unit 39 calculates the amplitude of the second vector calculated by the subtracting unit 34. The amplitude of the second vector is an example of the index that indicates the magnitude of the second vector. The amplitude calculating unit 39 calculates, as the amplitude of the second vector, for example, the square root of the sum of the square of the I component of the second vector and the square of the Q component of the second vector. The amplitude A(t) of the second vector calculated by the amplitude calculating unit 39 is represented by, for example, Equation (4) below.

A(t)=|x(t)−x(t−Δt)| (4)

Furthermore, the amplitude calculating unit 39 may also output the logarithmic value of the amplitude of the second vector calculated by the subtracting unit 34 to the second address generating unit 38 as the amplitude A(t) of the second vector.

The second address generating unit 38 normalizes the value of the input angle Δθᵢₙ(t) calculated by the subtracting unit 37 to the value with a predetermined number of bits and normalizes the value of the amplitude A(t) of the second vector calculated by the amplitude calculating unit 39 to the value with a predetermined number of bits. Then, the second address generating unit 38 generates the second address on the basis of the normalized values and then output the generated second address to the LUT 12. The second address generating unit 38 normalizes the value of the input angle Δθᵢₙ(t) calculated by the subtracting unit 37 to the value with the number of bits of, for example, M₁ and normalizes the value of the amplitude A(t) of the second vector calculated by the amplitude calculating unit 39 to the value with the number of bits of, for example, M₂. Then, the second address generating unit 38 generates the second address with the number of bits of (M₁+M₂) bits.

### Effect of the Second Embodiment

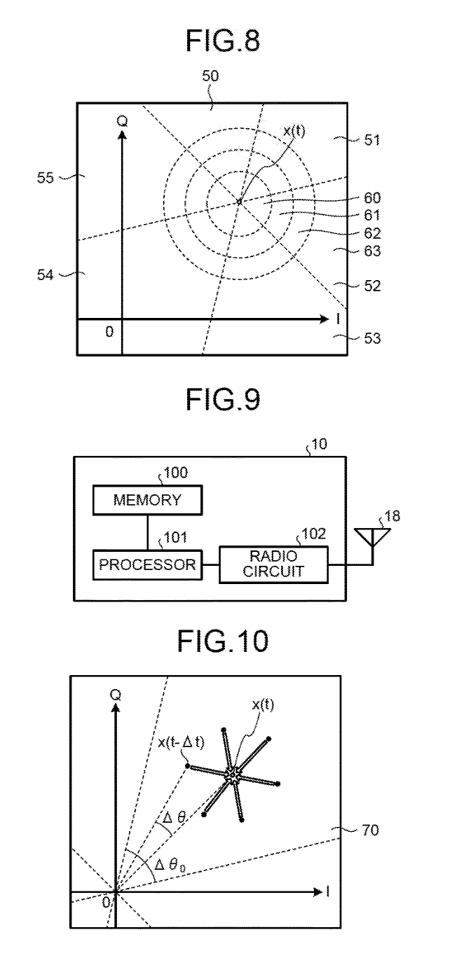

In this way, in the distortion compensation device 10 according to the second embodiment, the address generating unit 30 further calculates the magnitude of the second vector and the LUT 12 specifies the distortion compensation coefficient by further using the magnitude of the second vector. Consequently, in addition to the input angle, the LUT 12 can specify the distortion compensation coefficient, in accordance with an amount of change in the second vector, i.e., the distance between the current sample point x(t) of the transmission signal and the sample point x(t−Δt) of the transmission signal at the predetermined time before. Thus, for example, as illustrated in FIG. 8, in addition to the areas 50 to 55 indicating the respective angular ranges of the input angle Δθᵢₙ(t), areas 60 to 63 indicating the ranges of different amplitudes of the second vectors are generated with its center at the current sample point x(t) of the transmission signal.

Consequently, the distortion compensation device 10 can increase the resolution of the angle and the amplitude of the second vector in the area in which the amplitude of the transmission signal is large. Thus, the distortion compensation device 10 can further finely identify the frequency properties in the area in which the amplitude of the transmission signal is large and use different distortion compensation coefficients in accordance with each of the frequency properties. Therefore, the distortion compensation device 10 according to the embodiment can reduce the nonlinear distortion affected by the memory effect of the amplifier 16 more than before.

Hardware

In the following, hardware of the distortion compensation device 10 described in the first and the second embodiments will be described. FIG. 9 is a block diagram illustrating an example of hardware of the distortion compensation device 10. The distortion compensation device 10 includes, for example, as illustrated in FIG. 9, a memory 100, a processor 101, a radio circuit 102, and the antenna 18.

The radio circuit 102 performs a process, such as up conversion or the like, on the signal output from the processor 101 and transmits the processed signal via the antenna 18. Furthermore, the radio circuit 102 includes the amplifier 16. The radio circuit 102 performs a process, such as down conversion or the like, on the signal output from the amplifier 16 and feeds back the processed signal to the processor 101. The radio circuit 102 implements the function performed by, for example, the multiplier 11, the DAC 13, the up converter 14, the oscillator 15, the amplifier 16, the coupler 17, the down converter 19, an ADC 20 and the like.

The memory 100 stores therein various kinds of programs or the like that implement the function of, for example, the LUT 12, the subtracter 21, the complex conjugate calculating unit 22, the updating unit 23, and the address generating unit 30. By executing the programs read from the memory 100, the processor 101 implements the function of, for example, the LUT 12, the subtracter 21, the complex conjugate calculating unit 22, the updating unit 23, and the address generating unit 30. Furthermore, in the distortion compensation device 10 illustrated in FIG. 9, a single number of the memory 100, the processor 101, the radio circuit 102, and the antenna 18 are provided; however, regarding the memory 100, the processor 101, the radio circuit 102, and the antenna 18, multiple number of devices may also be provided.

Others

The technology disclosed in the present application is not limited to the embodiments described above and various modifications are possible as long as they do not depart from the spirit of the present application.

For example, in the first and the second embodiments described above, the address generating unit 30 generates the first address on the basis of the amplitude that is one of the indices of the magnitude of the first vector; however, the disclosed technology is not limited to this. For example, the address generating unit 30 may also generate the first address on the basis of the power that is one of the indices of the magnitude of the first vector. Furthermore, in the second embodiment described above, the address generating unit 30 generates the second address on the basis of the input angle and the amplitude that is one of the indices of the magnitude of the second vector; however, the disclosed technology is not limited to this. For example, the address generating unit 30 may also generate the second address on the basis of the input angle and the power that is one of the indices of the magnitude of the second vector.

Furthermore, in the second embodiment described above, the amplitude calculating unit 39 calculates the amplitude of the second vector; however, the disclosed technology is not limited to this. For example, regarding the sample points of a plurality of transmission signals at different time, the amplitude calculating unit 39 may also average the amplitude of the first vectors and calculate the ratio of the averaged amplitude of the first vector to the amplitude of the second vector. Specifically, for example, on the basis of Equation (5) below, the amplitude calculating unit 39 calculates the ratio R(t) of the average amplitude of the first vector to the amplitude of the second vector.

$$R ( t ) = 20 \times {log}_{10} \frac{\vert x ( t ) - x ( t - Δ t ) \vert}{\frac{\sum \vert x ( t ) \vert}{N}} \qquad ( 5 )$$

In Equation (5) above, N represents the number of the first vectors at different time.

The second address generating unit 38 generates the second address on the basis of the value of the input angle Δθᵢₙ(t) calculated by the subtracting unit 37 and the value of the ratio R(t) calculated by the amplitude calculating unit 39.

In this way, by specifying the distortion compensation coefficient on the basis of the ratio of the average amplitude of the first vector to the amplitude of the second vector, the distortion compensation device 10 can increase the resolution of the distortion compensation coefficient when the amplitude of the transmission signal is large. Consequently, the distortion compensation device 10 can reduce the nonlinear distortion of the amplifier 16 due to the memory effect or the like more than before.

Furthermore, in Equation (5) above, the logarithmic value obtained by dividing the amplitude of the second vector by the average amplitude of the first vector is calculated as the ratio R(t); however, as another example, the value obtained by dividing the amplitude of the second vector by the average amplitude of the first vector may also be calculated as the ratio R(t). Furthermore, in Equation (5) above, the logarithmic value of a value obtained by dividing the amplitude that is one of the indices of the magnitude of the second vector by the average amplitude that is one of the indices of the magnitude of the first vector is calculated as the ratio R(t); however, the disclosed technology is not limited to this. For example, the logarithmic value of a value obtained by dividing the power that is one of the indices of the magnitude of the second vector by the average power that is one of the indices of the magnitude of the first vector may also be calculated as the ratio R(t).

According to an aspect of an embodiment, it is possible to improve the distortion compensation performance while reducing an increase in the size of a circuit.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distortion compensation device comprising:
a calculating unit that calculates a magnitude of a first vector represented by using an origin in an IQ coordinate plane as a starting point and using a transmission signal point at a first time as an end point and that calculates an angle formed by the first vector and a second vector represented by using a transmission signal point at a second time that is predetermined time before the first time as a starting point and using the transmission signal point at the first time as an end point;
a specifying unit that specifies a distortion compensation coefficient by using the magnitude of the first vector and the angle calculated by the calculating unit; and
a distortion compensation unit that performs, by using the distortion compensation coefficient specified by the specifying unit, a predistortion process on a transmission signal that is input to an amplifier.

2. The distortion compensation device according to claim 1, wherein
the calculating unit further calculates a magnitude of the second vector, and
the specifying unit specifies the distortion compensation coefficient by further using the magnitude of the second vector calculated by the calculating unit.

3. The distortion compensation device according to claim 1, wherein
the calculating unit averages the magnitude of the first vectors located at a plurality of transmission signal points at different time and further calculates a ratio of the magnitude of the averaged first vector to the magnitude of the second vector, and
the specifying unit specifies the distortion compensation coefficient by further using the ratio calculated by the calculating unit.

4. A distortion compensation method comprising:
calculating a magnitude of a first vector represented by using an origin in an IQ coordinate plane as a starting point and using a transmission signal point at a first time as an end point;
calculating an angle formed by the first vector and a second vector represented by using a transmission signal point at a second time that is predetermined time before the first time as a starting point and using the transmission signal point at the first time as an end point;
specifying a distortion compensation coefficient by using the magnitude of the first vector and the angle; and
performing by using the specified distortion compensation coefficient, a predistortion process on a transmission signal that is input to an amplifier.
